(19) United States
(12) Patent Application Publication
(10) Pub. No.: US 2015/0323723 A1
(43) Pub. Date: Nov. 12, 2015

(54) ANTI-BURST OGS TOUCH PANEL

(71) Applicant: CANDO CORPORATION, Hsinchu County (TW)

(72) Inventors: Chi-Kuang LAI, Hsinchu County (TW); Wen-Chen LEE, Hsinchu County (TW)

(21) Appl. No.: 14/707,953

(22) Filed: May 8, 2015

(30) Foreign Application Priority Data
May 8, 2014 (TW) 103116361

(51) Int. Cl. G02B 5/30; G09G 5/00; G06F 3/047

(52) U.S. Cl. CPC G02B 5/3083; G02B 5/3025; G06F 3/047; G09G 5/003; G09G 2300/04

(57) ABSTRACT

An anti-burst, or so-called an anti-shatter, OGS (One-Glass-Solution) touch panel is provided. The OGS touch panel includes a cover lens of glass and a touch sensor layer formed on one side of the cover lens. The OGS touch panel further includes a polarizer, wherein the polarizer is bonded, by means of an adhesive layer included in the polarizer, to one side of the touch sensor layer which is the side opposite from the cover lens, or is bonded to one side of the cover lens which is the side opposite from the touch sensor layer. Because of the function of the adhesive layer included in the polarizer, the OGS touch panel as provided achieves the advantage of both being shatterproof and having a reduced total thickness.

### CROSS-REFERENCE TO RELATED APPLICATION(S)

This application claims priority under 35 U.S.C. §119(a) of the TW Patent Application No. 103116361, filed May 8, 2014 and entitled, “Anti-burst OGS Touch Panel,” which is hereby incorporated by reference in its entirety for all purposes.

### BACKGROUND OF THE INVENTION

1. Field of the Invention

The present invention relates to the structure of a One-Glass-Solution (OGS) touch panel, and more particularly, to the structure of an OGS touch panel with an anti-shatter feature that can prevent glass inside the touch panel from shattering.

2. Description of the Prior Art

Many electronic products nowadays are equipped with touchscreens which allow users to interact with machines by touching the screens, such as smartphones, tablet computers, interactive game consoles, touchscreen GPS navigation systems, etc. As these products have become more and more diversified and popular, the needs for touchscreens have also substantially increased. Electronic products with touchscreens tend to have user interfaces that are easier to use. By touching the display area on a screen with fingers or other objects, a user can perform operations in a more intuitive way, and that is why this type of electronic products are becoming even more popular.

A touchscreen is basically constructed by a touch panel and an LCD display module. Among the many types of touch panel structure designs, an OGS (One-Glass-Solution) touch panel is a type of touch panel structure that uses only one glass substrate (also known as the cover lens or the cover glass) and integrates the conductive layer (or the so-called touch sensor layer) with the glass substrate. That is, an OGS touch panel is formed by performing coating—coating a touch sensor layer (e.g., an ITO layer) on the inner side of the glass substrate—and etching processes directly on the glass substrate. In such OGS touch panel manufacturing process, another piece of glass and a bonding step can be reduced. As a result, the production cost can be lowered, and electronic products adopting OGS touch panels would turn out to be thinner and more compact to satisfy market needs.

FIG. 1 is a schematic view showing the structure of a conventional OGS touch panel. As FIG. 1A shows, an OGS touch panel 1 comprises a substrate 11 made of tempered glass, and a touch sensor layer 12 is disposed on the substrate 11. A shielding layer 13 (e.g., a black matrix layer) may also be disposed on the substrate 11 to shield the metal wiring around the substrate 11. To allow the formed panel structure bond to other films or layers more tightly and easily, the OGS touch panel 1 may also comprise an overcoat 14, so that the OGS touch panel 1 has a flatter surface.

As the OGS panel 1 has been cut from a parent glass sheet of a larger size, the OGS panel may have a drawback of insufficient strength after the cutting. Therefore, in existing designs, an anti-shatter film 15 is generally bonded to the overcoat 14 to prevent the cover lens 11 from shattering into pieces due to external forces. The OGS touch panel 1, having a structure as shown in FIG. 1, is further combined with an LCD display module (not shown) to accomplish a touch display device.

It is true that in the above OGS touch panel, the anti-shatter film can prevent the cover lens from shattering caused by external forces. However, anti-shatter films are conventionally made of polyester materials, and preventing glass substrates from shattering into pieces is the only function of these anti-shatter films. The bonding of an anti-shatter film to the panel structure not only increases the thickness and cost of a touch panel, but also causes problems such as yellow light, uneven surface, etc. to the touch panel. Also, the transmittance, touch sensitivity or power consumption of the touch panel may be affected.

Accordingly, there exists a need for an improved OGS touch panel structure, which can further realize lower production cost, has a reduced total thickness, and yet contains an anti-shatter feature.

### SUMMARY OF THE INVENTION

It is an object of the present invention to provide an anti-shatter OGS (One-Glass-Solution) touch panel which allows a touchscreen to have a reduced total thickness, allows lower production cost, and contains the indispensable anti-shatter feature.

It is a further object of the present invention to provide an anti-shatter OGS touch panel which allows a lower production cost, a reduced total thickness, and which can effectively reduce the reflection of ambient light while containing the indispensable anti-shatter feature.

To achieve the above objects, the present invention provides an anti-shatter OGS touch panel including a cover lens, a touch sensor layer, and a polarizer, wherein the touch sensor layer is formed on a surface of the cover lens, and the polarizer is bonded, by means of an adhesive layer, to one side of the cover lens which is the side opposite from the touch sensor layer.

Alternatively, according to the present invention, the polarizer is bonded to one side of the touch sensor layer which is the side opposite from the cover lens. Preferably, the OGS touch panel further includes an overcoat formed on one side of the touch sensor layer which is the side opposite from the glass substrate, and the polarizer is formed on one side of the overcoat which is the side opposite from the touch sensor layer.

Preferably, the OGS touch panel further includes an optical coating between the cover lens and the touch sensor layer.

Preferably, the polarizer is a linear polarizer.

To achieve the above objects, the present invention also provides an anti-shatter OGS touch panel including a cover lens, a touch sensor layer, and an optical retardation film, wherein the touch sensor layer is formed on one side of the cover lens, and the optical retardation film is bonded, by means of an adhesive layer (e.g., a pressure-sensitive adhesive layer) included therein, to one side of the touch sensor layer which is the side opposite from the cover lens.

Preferably, the OGS touch panel further includes an optical coating between the cover lens and the touch sensor layer.

Preferably, the OGS touch panel further includes an overcoat, wherein the overcoat is formed on one side of the touch sensor layer which is the side opposite from the cover lens, and the optical retardation film is formed on one side of the overcoat which is the side opposite from the touch sensor layer.

Preferably, the optical retardation film is a quarter-wave retardation film.

To achieve the above objects, the present invention further provides an anti-shatter OGS touch panel including a cover lens, a touch sensor layer, a polarizer, and an optical retardation film, wherein the touch sensor layer formed on one side of the cover lens; the polarizer is bonded, by means of an adhesive layer included therein, to one side of the touch sensor layer which is the side opposite from the cover lens; and the optical retardation film is formed on one side of the cover lens which is the side opposite from the touch sensor layer. The OGS touch panel is bonded to a display module by means of an air-bonding layer.

Alternatively, according to the present invention, the optical retardation film is formed on one side of the polarizer which is the side opposite from the touch sensor layer.

Preferably, the OGS touch panel further includes an optical coating between the cover lens and the touch sensor layer.

Preferably, the OGS touch panel further includes an overcoat, wherein the overcoat is formed on one side of the touch sensor layer which is the side opposite from the cover lens, and the optical retardation film is formed on one side of the overcoat which is the side opposite from the touch sensor layer.

Preferably, the polarizer is a linear polarizer.

Preferably, the optical retardation film is a quarter-wave retardation film.

The features, embodiments, and advantages of the aforementioned aspects and other aspects of the present invention will be further understood with reference to the non-limiting embodiments described herein and the accompanying drawings.

### BRIEF DESCRIPTION OF THE DRAWINGS

FIG. 1 is a schematic view showing the structure of a conventional OGS (One-Glass-Solution) touch panel according to the prior art;

FIG. 2A is a schematic view showing the structure of an anti-shatter OGS touch panel according to a first embodiment of the present invention;

FIG. 2B is a schematic view showing the structure of an anti-shatter OGS touch panel according to a second embodiment of the present invention;

FIG. 3A is a schematic view showing the structure of an anti-shatter OGS touch panel according to a third embodiment of the present invention;

FIG. 3B is a schematic view showing the structure of an anti-shatter OGS touch panel according to a fourth embodiment of the present invention; and

FIG. 4 is a schematic view showing the structure of an OGS touch display module according to an embodiment of the present invention.

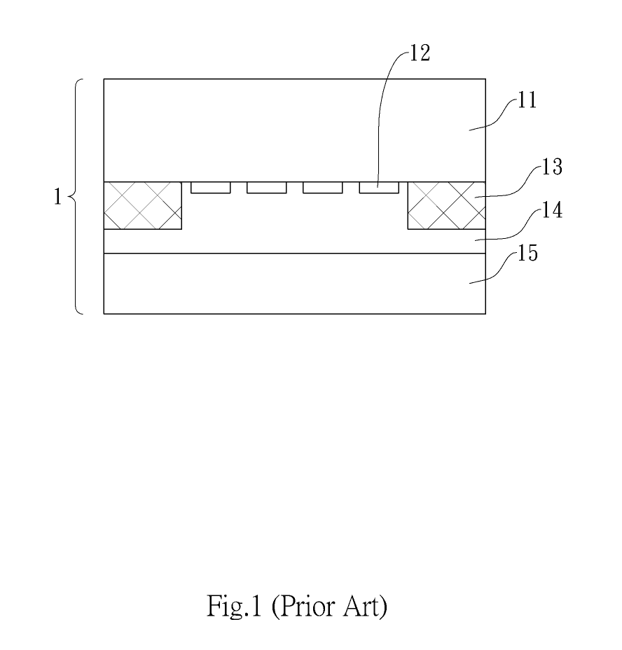

### DETAILED DESCRIPTION OF THE PREFERRED EMBODIMENTS

To better understand the features, aspects, advantages, and effects produced by the present invention, the invention will now be described more fully hereinafter by way of example and with reference to the accompanying drawings, in which preferred embodiments of the present invention are shown. It should be noted that the following description and accompanying drawings are given only as exemplary and do not necessarily present the actual scale or precise configuration for carrying out the present invention. Hence, the scale and configuration shown in any of the accompanying drawings should not be construed as limiting the scope of the claims for carrying out the invention. It is intended that the scope of the present invention be defined by the claims appended hereto.

The present invention now will be described more fully hereinafter with reference to the accompanying drawings, in which preferred embodiments of the invention are shown. It is to be understood that elements shown in these drawings are illustrated for the purpose of better explanation and are not necessarily presented according to the actual size and scale. In addition, to make the drawings simple and easy to understand, certain elements already known in prior art are not illustrated in some of the drawings.

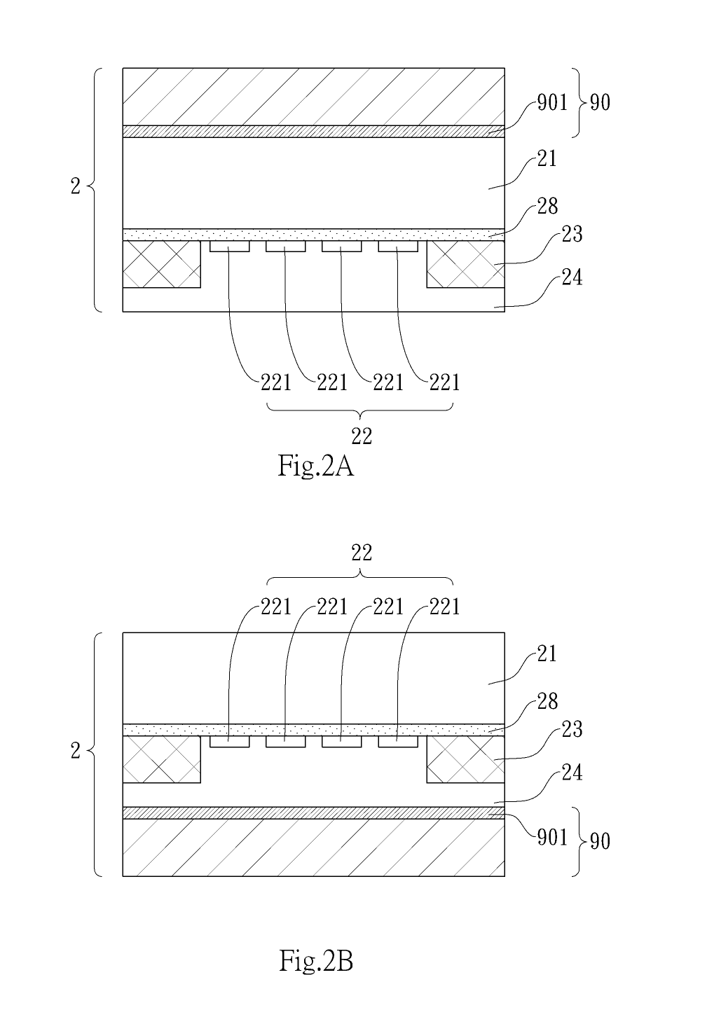

FIG. 2A is a schematic view showing the structure of an anti-shatter OGS touch panel according to a first embodiment of the present invention. As shown in FIG. 2A, the OGS touch panel 2 basically includes a cover lens 21, which is made of glass and also known as a cover glass. The touch sensor layer 22 is formed on an inner side (i.e., the module-facing side) of the cover lens 21. The cover lens 21 may be a tempered glass for protecting the display panel module, but it may also be an untempered glass. In this embodiment, the touch sensor layer 22 may be a sensor array consisting of a plurality of sensor units 221. The touch sensor layer 22 is formed by coating electrically conductive materials (such as ITO) onto the cover lens 21 and then going through an etching process. In another embodiment, the touch sensor layer 22 may consist of metal mesh, silver nanowire, or carbon nanotube sensor units to provide touch-sensitive functionality. Optionally, a shielding layer 23 (e.g., a black matrix layer) may be disposed on the cover lens 21 to shield the metal wiring at the peripheral area of the substrate, such that the metal wiring is invisible from external. Optionally, the OGS touch panel 2 may also contain an overcoat (also known as a planarization layer) 24, so that the OGS touch panel 2 has a planar surface which is conducive to subsequent bonding to other films or layers.

Preferably, the cover lens of the OGS touch panel is subjected to optical processing depending on actual needs. Alternatively, the cover lens may be provided with an optical coating on the surface thereof to adjust the optical properties (including, but not limited to, anti-glare feature, transmittance, etc.) thereof. To be more specific, the optional optical coating 28 may be formed on an inside surface of the cover lens 21 (as shown in FIG. 2A, the optical coating 28 is disposed between the cover lens 21 and the touch sensor layer 22) or on an outside surface of the cover lens 21 (not shown).

In this embodiment, the polarizer 90 is disposed on an outside surface (i.e., the outside-facing surface) of the OGS touch panel 2. To be more specific, the polarizer 90 is bonded to the OGS touch panel 2 by means of an adhesive layer 901 included in the polarizer 90. The adhesive layer may be a pressure-sensitive adhesive layer or other types of adhesive glue layer. Meanwhile, with the function of the adhesive layer 901 included in the polarizer 90, situations where the protective glass substrate 21 of the OGS touch panel 2 shatters into pieces due to external forces can be prevented. In addition, those skilled in the art may, according to the circumstances, separately apply the adhesive layer to the OGS touch panel 2 by coating the adhesive layer thereon or by bonding the adhesive layer thereto; thereafter, the polarizer 90 can be bonded to the OGS touch panel by means of the adhesive layer.

It should be noted that the configuration of the layers and films in the OGS touch panel is not limited to the one described above. For example, as shown in FIG. 2B, where the OGS touch panel 2 according to a second embodiment of the present invention is illustrated, the polarizer 90 may be bonded to another side of the touch sensor layer 22, i.e., the side opposite from the cover lens 21, by means of the adhesive layer 901. That is, the polarizer 90 may be bonded to a surface of the overcoat 24 which is opposite from the touch sensor layer 22. This configuration can also prevent the glass in the OGS touch panel 2 from shattering into pieces due to external forces.

In the first and second embodiments described above, the polarizer 90 is a linear polarizer. When the OGS touch panel 2 is further bonded to an LCD display module (not shown) to form a touch display device, the polarizer 90 within the OGS touch panel 2 is used as a front polarizer of the touch display device. That is, an LCD display module needs only a rear polarizer included therein when the LCD display module is to combine with the OGS touch panel 2 according to the above embodiments. There is no need to provide separate polarizers on the upper and lower sides of the LCD display module. Moreover, the polarizer 90 also provides an anti-shatter function for the OGS touch panel 2, and can prevent the glass of the OGS touch panel 2 from shattering into pieces after the OGS touch panel is broken. In the first and second embodiments of the present invention, the use of an anti-shatter film as utilized in a conventional OGS touch panel is removed, yet the anti-shatter result for the touch panel can also be achieved. Therefore, apart from lowering the production cost, the present invention can also achieve the result of reducing the total thickness of a touch display device.

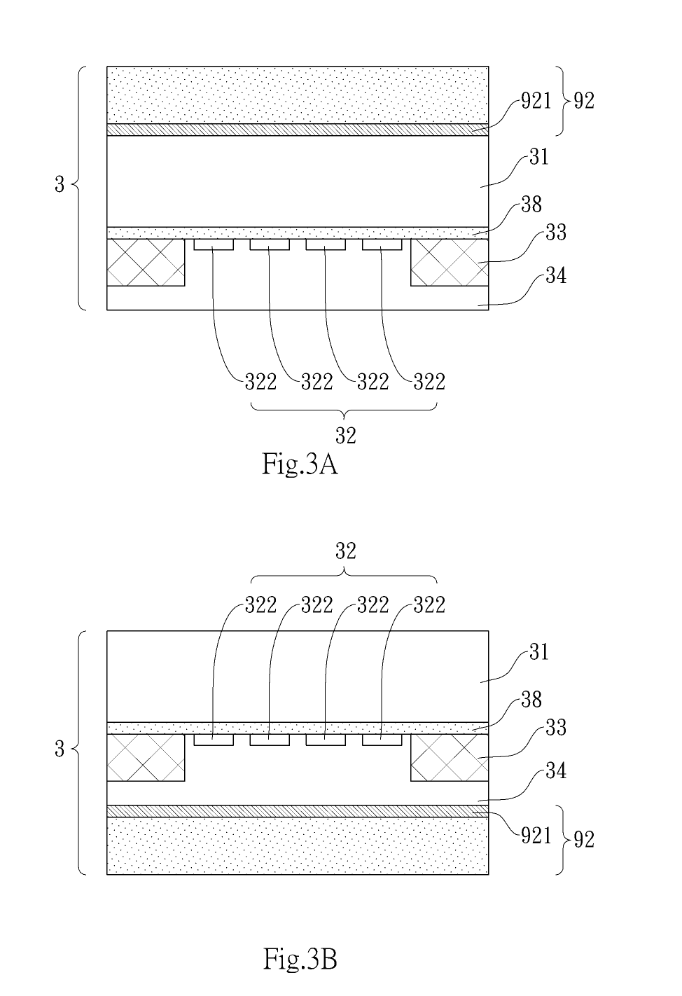

FIG. 3A is a schematic view showing the structure of an anti-shatter OGS touch panel according to a third embodiment of the present invention. As shown in FIG. 3A, the OGS touch panel 3 includes a cover lens 31, and a touch sensor layer 32 formed on an inside surface (i.e., the module-facing surface) of the cover lens 31. In this embodiment, the touch sensor layer 32 may be a sensor array consisting of a plurality of sensor units 321. As described previously, the touch sensor layer 32 is formed by coating electrically conductive materials (such as ITO) onto the cover lens 31 and then going through an etching process. In another embodiment, the touch sensor layer 32 may consist of metal mesh, silver nanowire, or carbon nanotube sensor units to provide touch-sensitive functionality. Optionally, a shielding layer 33 (e.g., a black matrix layer) may be disposed on the cover lens 31 to shield the metal wiring at the peripheral area of the substrate. Optionally, the OGS touch panel 3 may also contain an overcoat (also known as a planarization layer) 34, so that the OGS touch panel 3 has a planar surface which is conducive to subsequent bonding to other films or layers.

In this embodiment, the cover lens of the OGS touch panel is subjected to optical processing depending on actual needs. Alternatively, the cover lens is provided with an optical coating on the surface thereof to adjust its optical properties (for example, but not limited to, anti-glare feature, transmittance, etc.). To be more specific, an optional optical coating 38 may be formed on an inside surface of the cover lens 31 (as shown in FIG. 3A, the optical coating 38 is located between the cover lens 31 and the touch sensor layer 32) or on an outside surface of the cover lens 31 (not shown).

In this embodiment, an optical retardation film (also known as a waveplate) 92 is disposed on an outside surface (i.e., the outside-facing surface) of the OGS touch panel 3. To be more specific, the optical retardation film 92 is bonded to the OGS touch panel 3 by means of an adhesive layer 921. The adhesive layer may be a pressure-sensitive adhesive layer or other types of adhesive glue layer. Meanwhile, the optical retardation film 92 itself can prevent the protective glass substrate 31 of the OGS touch panel 3 from shattering into pieces due to external forces.

Similarly, the configuration of the optical retardation film in the OGS touch panel is not limited to the one described above. For example, as shown in FIG. 3B, in the OGS touch panel 3 according to the present invention, the optical retardation film 92 may be bonded to another side of the touch sensor layer 32, i.e., the side opposite from the cover lens 31. That is, the optical retardation film 92 may be bonded to a surface of the overcoat 34 which is opposite from the touch sensor layer 32. This configuration can also prevent the glass in the OGS touch panel 3 from shattering into pieces due to external forces.

In the third embodiment described above, the optical retardation film 92 is a quarter-wave retardation film that can result in a retardation of ¼ wavelength. In the third embodiment of the present invention, the use of an anti-shatter film as utilized in a prior art OGS touch panel can also be removed; the anti-shatter result for the touch panel can also be achieved without using any anti-shatter films. In addition, there is no need to bond an additional anti-shatter film to the touch panel. Therefore, process yields can be effectively improved, production cost lowered, and the total thickness of a touch display device reduced.

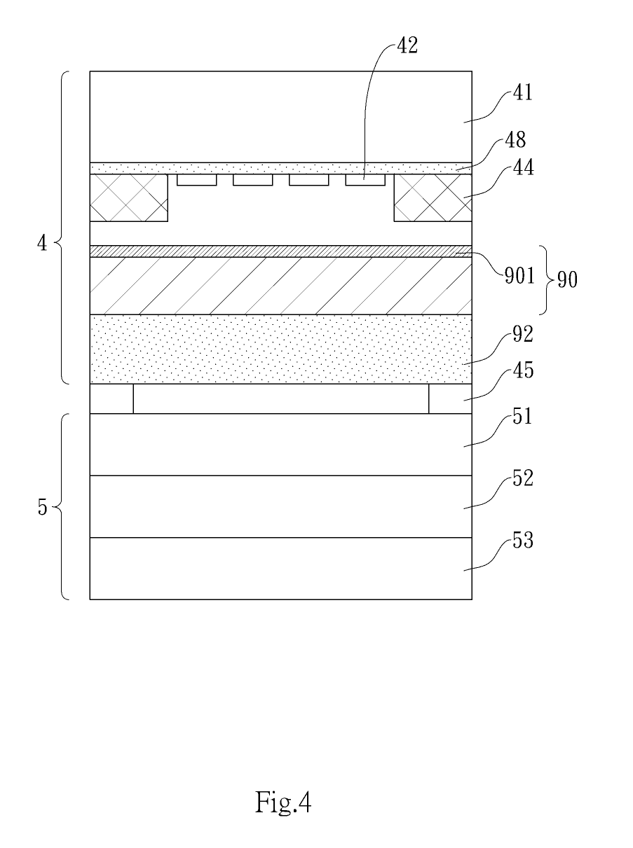

FIG. 4 is a schematic view showing the structure of an OGS touch display module according to a fourth embodiment of the present invention. In this embodiment, an OGS touch panel 4 is bonded to an LCD display module 5 by means of an air-bonding layer to form the OGS touch display module. As FIG. 4 shows, the OGS touch panel 4 comprises a cover lens 41, a touch sensor layer 42, a polarizer 90, and an optical retardation film 92; the touch sensor layer 42 is patterned and comprises a plurality of sensor units 422 formed on an inside-facing side (i.e., the module-facing side) of the cover lens 41. Depending on actual needs, an overcoat (also known as a planarization layer) 44 may be further formed on the touch sensor layer 42 to provide a planar surface which is conducive to subsequent bonding to other films or layers. As described above, various optical processing techniques may be applied to the cover lens of the OGS touch panel depending on actual needs. Alternatively, an optical coating may be disposed on the surface of the cover lens to adjust the optical properties (e.g., anti-glare feature, transmittance, etc.) of the cover lens. As the embodiment in FIG. 4 shows, an optional optical coating 48 may be formed on an inside surface of the cover lens 41 (i.e., between the cover lens 41 and the touch sensor layer 42), or on an outside surface of the cover lens 41 (not shown). Moreover, in this embodiment, a polarizer 90 is bonded, by means of an adhesive layer 901 included in, to one side of the touch sensor layer 42 which is the side opposite from the cover lens 41. For example, the polarizer 90 is bonded directly to the module-facing surface of the overcoat 44. In this embodiment, an optical retardation film 92 is bonded, by means of an adhesive layer 921 included in the optical retardation film 92, to one side of the polarizer 90 which is the side opposite from the touch sensor layer 42 (i.e., the module-facing side of the polarizer 90). As described above, since the polarizer 90 and the optical retardation film 92 each has its own adhesive layer and surface protective layer, the shattering of the protective glass substrate 41 of the OGS touch panel 4 in this embodiment due to external forces can be prevented.

As described above, the OGS touch panel 4 in this embodiment is bonded to an LCD display module 5 by means of an air-bonding layer 45. In this embodiment, the polarizer 90 within the OGS touch panel 4 is used as a front polarizer of the touch display device. As such, the LCD display module 5 combining with the OGS touch panel 4 is configured to comprise a color filter 51, a TFT-LCD layer 52 and a rear polarizer 53; that is, there is no need to form separate polarizers at both upper and lower sides of the LCD display module 5.

Those of ordinary skill in the art would understand that the configuration or order of layers shown in FIG. 4 is only exemplary, and that an OGS touch panel according to the present invention may have other configurations of layers in various embodiments. For example, in an alternative embodiment, the optical retardation film is disposed directly on the module-facing side of the overcoat, and the polarizer is further disposed on the optical retardation film; or, either of the polarizer and the optical retardation film or both of them are disposed on one side of the cover lens which is the side opposite from the touch sensor layer, e.g., on the outside-facing surface of the cover lens, but not limited to such example.

The optical retardation film 92 described above is a quarter-wave retardation film that can result in a retardation of ¼ wavelength. According to an embodiment of the present invention, the OGS touch panel integrates both the polarizer and the optical retardation film in its structure. As stated above, the OGS touch panel contains the anti-shatter feature. In addition, when the OGS touch panel is further combined with an LCD display module by means of an air-bonding layer to form an OGS touch display module, the quarter-wave retardation film and the polarizer within the OGS touch panel can further produce circular polarized light, so that light will rotate the polarized direction to reduce the refection of ambient light.

To sum up, an anti-shatter OGS touch panel according to the embodiments of the present invention includes a polarizer (e.g., linear polarizer) and/or an optical retardation film (e.g., quarter-wave retardation film) integrated in the touch panel structure. There is no need to use a conventional anti-shatter film to achieve the anti-shatter result, whereas the shattering of the glass substrate can be prevented. Moreover, the polarizer can further work with the quarter-wave retardation film to alter the polarized direction of light, thereby reducing the reflection of ambient light. Since the anti-shatter OGS touch panel according to the present invention does not contain a conventional anti-shatter film, the total thickness of a touch display module can be reduced and production cost be lowered. Moreover, according to the design of the present invention, a linear polarizer is bonded inside the OGS touch panel to replace a conventional front polarizer used in an LCD display module. As such, when a front polarizer is bonded poorly to the OGS touch panel of this invention, only the OGS touch panel, instead of the entire LCD display module which is more costly, needs to be discarded. Therefore, the present invention can effectively reduce scrap costs and eventually reduce the overall cost of manufacturing OGS touch display modules. The present invention indeed involves novelty and inventive steps, and is also industrial applicable, competitive, and worth developing.

All of the advantageous features disclosed in this specification may be combined in any combination. Each feature disclosed in this specification may be replaced by an alternative feature serving the same, equivalent, or similar purpose. Thus, except for those particularly distinctive features, each feature disclosed is only an example of a generic series of equivalent or similar features.

While this invention has been described by way of preferred embodiments, it is to be understood that this invention is not limited hereto, and that various alterations and modifications can be made by those skilled in the art without departing from the spirit and scope of this invention.

What is claimed is:

1. An OGS (One-Glass-Solution) touch panel, comprising:
a cover lens of glass;
a touch sensor layer formed on one side of the cover lens; and
a polarizer bonded, by means of an adhesive layer, to one side of the touch sensor layer which is the side opposite from the cover lens, or to one side of the cover lens which is the side opposite from the touch sensor layer.

2. The OGS touch panel according to claim 1, further comprising an overcoat formed between the touch sensor layer and the polarizer.

3. The OGS touch panel according to claim 1, wherein the polarizer is a linear polarizer.

4. An OGS (One-Glass-Solution) touch panel, comprising:
a cover lens of glass;
a touch sensor layer formed on one side of the cover lens; and
an optical retardation film bonded, by means of an adhesive layer, to one side of the touch sensor layer which is the side opposite from the cover lens.

5. The OGS touch panel according to claim 4, further comprising an overcoat, wherein the overcoat is formed on one side of the touch sensor layer which is the side opposite from the cover lens, and the optical retardation film is formed on one side of the overcoat which is the side opposite from the touch sensor layer.

6. The OGS touch panel according to claim 4, wherein the optical retardation film is a quarter-wave retardation film.

7. An OGS (One-Glass-Solution) touch panel, comprising:
a cover lens of glass;
a touch sensor layer formed on a surface of the cover lens;
a polarizer bonded, by means of an adhesive layer, to one side of the touch sensor layer which is the side opposite from the cover lens; and
an optical retardation film formed on one side of the polarizer which is the side opposite from the touch sensor layer, or formed on one side of the cover lens which is the side opposite from the touch sensor layer,
wherein the OGS touch panel is bonded to a display module by means of an air-bonding layer.

8. The OGS touch panel according to claim 7, further comprising an overcoat, wherein the overcoat is formed on one side of the touch sensor layer which is the side opposite from the cover lens, and the polarizer is formed on one side of the overcoat which is the side opposite from the touch sensor layer.

9. The OGS touch panel according to claim 7, wherein the polarizer is a linear polarizer.

10. The OGS touch panel according to claim 7, wherein the optical retardation film is a quarter-wave retardation film.
